(19) United States
(12) Patent Application Publication
(10) Pub. No.: US 2013/0046698 A1
(43) Pub. Date: Feb. 21, 2013

(54) SYSTEM AND METHOD OF CREATING AND AUTHENTICATING A SECURE FINANCIAL INSTRUMENT

(71) Applicants: Todd Gagerman, Northbrook, IL (US); Michael Jakubiec, Bloomingdale, IL (US); Masis Sarkisian, Des Plaines, IL (US)

(72) Inventors: Todd Gagerman, Northbrook, IL (US); Michael Jakubiec, Bloomingdale, IL (US); Masis Sarkisian, Des Plaines, IL (US)

(73) Assignee: ICERTIFY LLC, Northbrook, IL (US)

(21) Appl. No.: 13/210,463

(22) Filed: Aug. 16, 2011

(51) Int. Cl. G06Q 20/40

(52) U.S. Cl. 705/71

(57) ABSTRACT

A system and method for creating secure financial paper documents (such as checks and money orders) by issuing agents that can be readily verified by redeeming agents in real time using existing computer and network technology.

### BACKGROUND OF THE INVENTION

1. Field of the Invention

This invention relates to a system and method for creating and negotiating secure financial paper instruments, and for authenticating the same through electronic verification.

2. Description of the Related Art

Millions of secure financial instruments (SFIs) such as checks, money orders and bank drafts are negotiated every day. When a check is negotiated, for example, it is presented to a redeeming agent such as a bank, merchant or currency exchange, who then provides money or products in exchange for the instrument. The redeeming agent then converts the instrument into currency by taking it to a bank and receiving payment thereon. The bank then begins the process of clearing the check, typically by converting it into an electronic file and sending that file to a clearinghouse. The clearinghouse determines which bank the check is drawn from and sending that bank a copy of the electronic file so the issuing bank can charge the check against the payee's account.

Each year redeeming agents take in billions of dollars in bad checks. Bad checks include checks that forged with the wrong amount or payee name, checks that are negotiated by someone impersonating the payee, counterfeit checks, and checks written on closed accounts or accounts without sufficient funds. Check fraud can take many forms, including the following:

Forgery/Making False Documents

Forgery is a growing problem. With advances in desktop publishing and other technological advances, it has become fairly easy to create phony checks and other financial documents such as money orders. Exacerbating the problem is that the redeeming agent (those cashing checks or money orders) often does not have recourse against the presenter. As a result, many merchants no longer accept checks or money orders.

The greatest fraud currently taking place is with postal money orders, where the person perpetrating the fraud creates a bogus postal money order instrument and then attempts to redeem it for cash or merchandise.

Alteration of Documents

Actual authentic money orders can be altered utilizing several techniques. For example, a fraudster may purchase a money order for $10, then “wash” the money order and change the amount to $1,000. The paper looks official, but when the money order hits the maker's bank, it will be returned. With the present system, it is impossible to alter an item without it being detected.

Photocopying of Authentic Instruments

Actual authentic money orders may be “copied”. One technique is to make tens or more copies of an actual money order. Then the money orders are sold to stooges, who then all cash them within a few days. Should a cashing agent call the issuer, all information will match and the item will be “authenticated”. In the end after all items have been presented to the makers bank (at least 1 or 2 days later), only 1 item will be paid, and those who took facsimiles will be out money or merchandise. With the present system, for those who participate, only 1 item will make it into the system. All other items will be rejected in real time.

Incorrectly Stored Money Order Numbers

Money order forms have the money order number pre-printed upon them. The problem arises when the computer doing the printing (typically with an impact printer), believes the number on the money order is different than it actually is. This provides for the electronic money order number being stored differently than the actual money order number. Reconciliation and authentication of documents becomes difficult. There are a number of ways in which the money order can get out of sequence. With the present system, money order numbers are printed as the money order is printed. Therefore, the computer and the actual document always remain in synch

Current Solutions to Check and Money Order Fraud

To address the problems noted above, the existing technology has focused on two types of solutions: (1) Using “security paper” and (2) using third party verification services such as “positive pay”.
(1) Security Paper (Manual Authentication)

Financial paper documents, whether checks, money orders or other documents, are printed on some type of official “security” paper. Of those merchants that still accept checks, some rely on a cursory examination of the type and quality of the paper to determine the check's authenticity. But there are many problems with simply relying on the type and quality of the paper. For instance, paper may be stolen by those attempting to commit fraud and used to make copies of financial documents. Additionally, an actual paper document can be “washed” or altered. Utilizing today's desktop publishing capabilities, it is easier than ever to fake money orders or checks.

As already noted above, paper can be stolen by those attempting to commit fraud and used to make copies of financial documents.
(2) Third Party Verification Services
(a) “Positive Pay” (Third Party Verification After Negotiation)

Positive pay is a product designed by banks to protect themselves and their clients. All financial documents are first registered at the maker's bank. When they are presented through the banking system, the maker's bank then knows immediately if the item is a correct item or not. But even positive pay has drawbacks. For one, positive pay is designed to protect the instrument maker—so bogus and altered items are not paid. Positive pay does nothing to protect those actually accepting the item in the first place.
(b) Phone Verification (Third Party Verification Before Negotiation)

Another method of authenticating financial documents is for the entity collecting the document for payment to verify by phone with the maker of the item. Again, this does nothing to insure that multiple items are not being presented within a short time frame. An item will remain “open” until it hits the maker's bank. In that time, 3, 4 or more duplicate items may have been cashed. Additionally, it is timely to make a telephone call, and in truth, the company being called may be completely false itself and as such is part of the fraud.

Objects of the Invention

Having certainty with respect to financial instruments is a crucial part of a free-flowing economic system. By utilizing the present system, most types of fraud will be eliminated, and the negotiability of such paper financial documents will be restored.

It is an object of the present invention to provide a system and method of creating a financial paper document that can be readily authenticated.

Further and additional objects will appear from the description, accompanying drawings, and appended claims.

### BRIEF SUMMARY OF THE INVENTION

The present invention is system and method for creating and verifying a secure financial instrument. The system requires the party selling the secure financial document (issuing agent) and the party cashing the secure financial instrument (redeeming agent) have a computer connected through the internet to a central server operated by a third party authentication service provider. The issuing agent should have a printer for printing the money order, and the redeeming agent should have a check imaging device. The software component of the system includes secure financial instrument creation software designed for use by issuing agent and document authentication software designed for use by redeeming agent. The software may reside on the issuing agent's and redeeming agent's computer, or on a central server accessible to both issuing agents and redeeming agents. A database comprising a list of all participating issuing agents may reside on either each issuing agent's computer or the central server. This database will have account information as well as all issuing agents' public encryption keys.

The method for creating a secure financial instrument (such as a money order) is also provided, the system comprises the steps of:

pre-registering the issuing agent and a redeeming agent, assigning the issuing agent and the redeeming agent a private encryption key unique to each agent, and creating issuing agent information accessible to a third party authentication service;

providing document creation software usable by the issuing agent and providing document authentication software usable by the redeeming agent;

providing a central server, operated by the third party authentication service, on which resides a database accessible by the issuing agent and the redeeming agent;

enabling the issuing agent to input into the database SFI data relating to the secure financial instrument, the SFI data including a routing number, an ABA account number, a dollar amount, an issue date and remitter, payee and purchaser information;

enabling the third party authentication service to check the validity of the SFI data and the issuing agent information to confirm that the secure financial instrument has not already been sold;

enabling the third party authentication service to determine whether a committed entry already exists in the database;

enabling the issuing agent to request a two dimensional bar code to accompany the secure financial instrument;

generating a two dimensional barcode;

enabling the issuing agent to issue the secure financial instrument, either in electronic form or in paper form by printing the secure financial instrument on site, the secure financial instrument including the two dimensional bar code and a digital signature; and

uploading the SFI data to the central server.

The invention also contemplates a method of enabling a redeeming agent to authenticate a negotiable instrument in real time is also provided, the method comprising the steps of:

receiving from a customer a printed negotiable instrument, the negotiable instrument including a two dimensional bar code, a signature section and a digital signature residing in a signature section, the two dimensional bar code containing negotiable instrument information about the negotiable instrument, wherein the negotiable instrument information has been formerly entered into a database residing on a central server operated by a third party authentication service as a database entry;

enabling the redeeming agent to input locally on the redeeming agent's computer selected data regarding the negotiable instrument;

comparing locally the negotiable instrument information in the bar code to the selected data and verifying the digital signature;

transmitting the selected data to the third party authentication service so that the third party authentication service can compare the bar code information on the negotiable instrument to the selected data as well as to the database entry in order to verify that the negotiable instrument has not been cashed and then send the redeeming agent an authorization code.

### BRIEF DESCRIPTION OF THE DRAWINGS

FIG. 1 is a schematic diagram showing the flow of information and other items among a customer, issuing agent, redeeming agent, redeeming agent bank and a third party authentication service provider.

FIG. 2 is a schematic diagram showing a method of creating and selling a secure financial instrument according to the invention.

FIG. 3 is a schematic diagram showing a method of verifying and cashing a secure financial instrument according to the present invention.

FIG. 4 is a schematic diagram showing a method of queuing a secure financial instrument request according to the present invention.

### DETAILED DESCRIPTION OF THE INVENTION

While this invention may be embodied in many forms, there is shown in the drawings and will herein be described in detail one or more embodiments with the understanding that this disclosure is to be considered an exemplification of the principles of the invention and is not intended to limit the invention to the illustrated embodiments.

### System Overview

The present invention is system and method for creating a secure financial instrument (SFI) such as a money order, a check, a voucher, a coupon, a bank draft, or an electronic image of the previous listed examples, by an issuing agent (e.g. a consumer bank), and enabling a redeeming agent (e.g. a merchant or currency exchange) to readily verify the SFI with a third party authentication service provider (TPAS) prior to negotiating (cashing) the SFI.

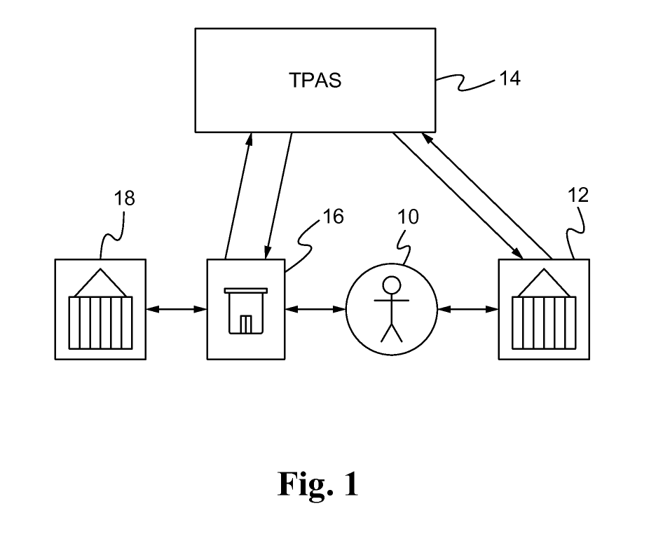

FIG. 1 is a schematic diagram showing the flow of information and documents during the course of creating and negotiating a secure financial instrument according the present invention among a customer 10, issuing agent 12, third party authentication service provider 14 (TPAS), redeeming agent 16 and redeeming agent bank 18. In a typical scenario, the customer 10 requests a secure financial instrument such as a money order (MO), from an issuing agent 12 such as a customer bank. The issuing agent 12 sends the money order request to a third party authentication service provider 14 or to a local software component. If the data is valid, the MO is registered into the third party authentication service provider's system and the TPAS sends the issuing agent 12, if requested, a barcode. The issuing agent 12 then issues the money order, typically in printed form, to the customer 10.

The money order typically includes a two dimensional bar code and digital signature that are used for verification during negotiation. As soon as the money order is created, all information about the money order is uploaded in real time to a Server residing with the TPAS, or queued for later transmission if the network is down.

To negotiate (cash) the money order, the customer 10 may present the money order to a currency exchange or other redeeming agent 16. When the money order is presented to the redeeming agent 16, the redeeming agent 16 inputs data regarding the money order into the authentication system, typically by scanning the money order on a scanner and/or keying in selected information. The data is analyzed, either by a software component residing in the redeeming agent's computer, or by a software component residing in the third party authentication service provider's computer, to determine whether the money order is authentic, that is, whether the information on the money order matches information in the bar code and digital signature, and whether the instrument has been negotiated. The digital signature also is used by the redeeming agent 16 to confirm that the money order was created by a TPAS registered issuing agent 12 and that it has not been altered in any way.

Determining whether a financial instrument has been negotiated requires that the network be up and running. In the rare instance when the network is not up and running the system sends the redeeming agent 16 a message warning the agent 16 that the system cannot determine whether the instrument has been negotiated. Should the network be down, the request for authentication is queued for later processing.

If the money order is deemed to be authentic and not yet negotiated, the redeeming agent 16 may elect to accept the money order from the customer 10.

The redeeming agent 16 may eventually deposit the SFI with his redeeming agent bank 18, which in turn may forward the SFI to a Federal Reserve Bank or other clearing bank (not shown in FIG. 1).

### System Software and Hardware

The system enabling the issuance, authentication and negotiation of secure financial instruments requires the party selling the SFI, typically a participating issuing agent 12, and the party cashing the SFI, the redeeming agent 16, to have a computer connected through the internet to a central server operated by the third party authentication service provider 14. The issuing agent 12 should have a printer for printing the money order, and the redeeming agent 16 should have a check imaging device.

The software component of the system includes secure financial instrument creation software designed for use by issuing agent 12 and document authentication software designed for use by redeeming agent 16. The software may reside on the issuing agent's and redeeming agent's computer, or on a central server accessible to both issuing agents 12 and redeeming agents 16.

A database comprising a list of all participating issuing agents 12 may reside on either each issuing agent's computer or the central server. This database will have account information as well as all issuing agents' public encryption keys.

### Issuing Agent Registration

Should a customer bank or other financial institution wish to be an issuing agent that is part of the TPAS network, the financial institution must become a registered issuing agent 12. During the registration process, the issuing agent 12 is authenticated using standard business practices in the banking community and given a one-time use personal identification number (PIN). During the registration process issuing agent information (a.k.a. point of sale or POS information) is created that is registered with the TPAS 14 through the use of a distributed software component. The authentication system employs conventional asymmetric encryption to enable system users (issuing agents and redeeming agents) to encrypt and decrypt information transmitted to and from the TPAS central server. Accordingly, one of the elements received from the TPAS 14 during registration is a private encryption key. A public encryption key is stored on the TPAS central server, while the private encryption key is erased upon reception by the issuing agent software component.

### Creating and Selling a Secure Financial Instrument (SFI)

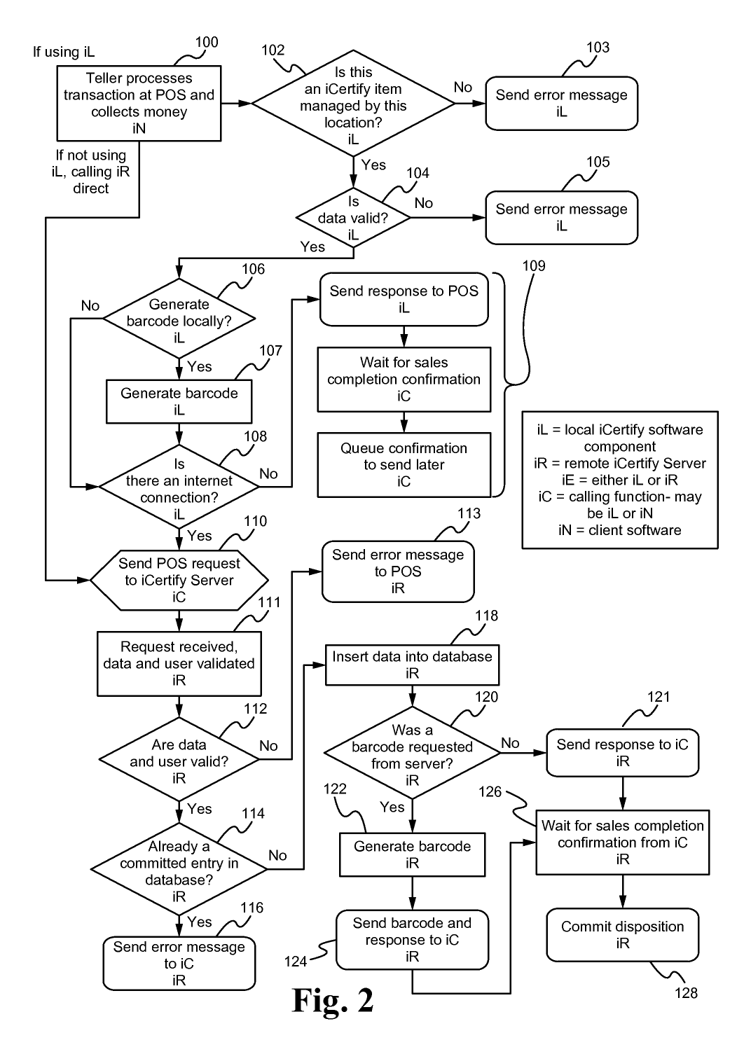

FIG. 2 is a schematic diagram showing a method of creating (selling) a secure financial instrument such as a money order according to the invention. The method accommodates issuing agents 12 who have the secure financial instrument creation software residing on their own computer, and those who access the software residing on the TPAS central server. In the latter case, the issuing agent 12 creates the money order or other SFI, and then provides the data relating to the SFI to the third party authentication provider 14. In general, the method comprises the following steps:

Step 100: The issuing agent 12 (a.k.a. “maker” or “seller”) at the point of sale (“POS”) receives a money order Request from a customer 10 (aka “payee”), processes the transaction and collects payment from the customer 10. Processing the transaction involves one of two steps: If the issuing agent 12 is using SFI creation software that resides locally (on the issuing agent's computer), then the method proceeds to step 102. If on the other hand the issuing agent 12 is using SFI creation software residing on the TPAS (remote) central server, then the method system proceeds directly to step 110.

Step 102: The issuing agent 12 inputs into the issuing agent's computer data relating to the requested money order. The data may include (1) a routing number and/or ABA account number, (2) a sequence number, (3) a dollar amount, (4) an issue date, (5) a purchaser (customer) name, (6) the system date and time, (7) an expiration date, (8) a maker name or ID, (9) login and security credentials, and (10) remitter and payee names. The system then checks to confirm that the routing number and ABA account number belong to the issuing agent 12.

Step 103: If the routing number and ABA account number do not match the issuing agent's, then the system sends an error message to the issuing agent 12.

Step 104: If the routing number and ABA account number match the issuing agent's, the system then checks the validity of the rest of the data, including making sure that all the information has been entered correctly.

Step 105: If there are any errors in data entry, the system sends an error message to the issuing agent 12.

Step 106: If the data is valid, the system determines whether a barcode is to be generated locally or not at all.

Step 107: If, as will usually be the case, the barcode is to be generated locally, the local, issuing agent's computer generates a bar code (as an image file) specific to the money order.

Step 108: The data necessary for the creation of the instrument is queued for later transmission (Step 109) if an internet connection or server is unavailable. Otherwise, the system proceeds to step 110.

Step 109: If there is no internet connection available, the local computer “waits” for a sales completion confirmation and queues the instrument creation information to be sent later.

Step 110: If the issuing agent 12 is using SFI generating software residing on the TPAS server, and there is an internet connection available, the issuing agent 12 can send the SFI Request to the third party authentication service 14.

Step 111: The TPAS 14 receives the SFI Request, which includes information about the SFI and the issuing agent 12.

Step 112: The TPAS 14 checks the validity of the data and the issuing agent 12.

Step 113: If the data and/or issuing agent 12 are not valid, the TPAS sends the issuing agent 12 an error message.

Step 114: If the data and issuing agent 12 user are valid, the TPAS determines whether a committed entry already exists in the TPAS database.

Step 116: If the committed entry already exists in the TPAS database, the TPAS sends the issuing agent 12 an error message.

Step 118: If the committed entry does not already exist in the TPAS database, the TPAS 14 inserts the data into the remote TPAS database.

Step 120: If a barcode was not requested (that is, if the bar code was generated locally (see step 107), or not at all) the TPAS 14 sends a response to the issuing agent (Step 121). The system then proceeds directly to step 126.

Step 122: If a barcode was requested, the TPAS 14 generates a barcode (as an image file).

Step 124: The TPAS 14 sends the barcode and response to the issuing agent 12.

Step 126: The issuing agent 12 waits for a sales completion confirmation from the TPAS 14.

Step 128: Once the issuing agent 12 receives a sales completion confirmation from the TPAS 14, the issuing agent 12 can print out the money order, including printing the bar code and a digital signature residing in a signature section of the money order, and issue it to the customer 10. If the money order (or other SFI) is in electronic form, the money order can be transmitted to the customer 10 by email or any suitable means of electronic transfer. If the SFI is in physical form, it can be handed to the customer 10, mailed, or transferred by any suitable means.

### The Secure Money Order

When an issuing agent 12 issues a money order, the majority of the information about the money order, ie: amount, date written, account, money order number, purchaser, remitter and payee, is written into the two dimensional bar code which resides in the signature section of the paper instrument. Additionally, a digital signature is added into the two dimensional bar code.

### Cashing a Secure Financial Instrument (SFI)

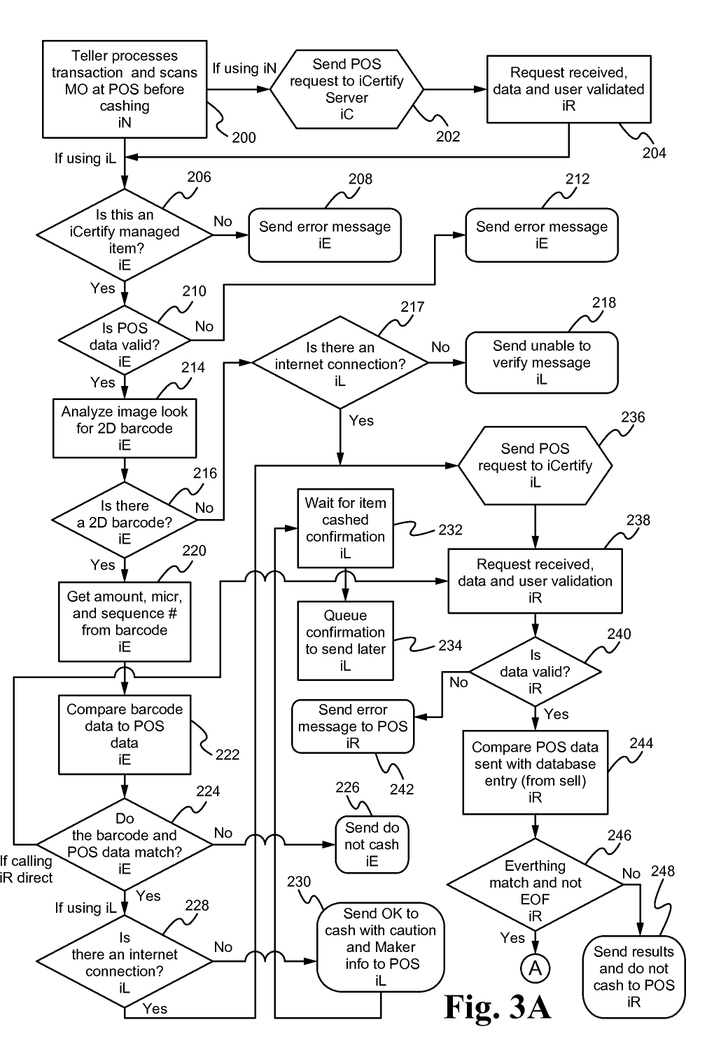

FIG. 3 is a schematic diagram of a method of cashing a secure financial instrument after first authenticating it according to the present invention. In general, the method comprises the following steps:

Step 200: Upon receiving from a customer 10 a negotiable secure financial instrument, the redeeming agent 16 (typically a currency exchange service or other merchant) inputs selected data regarding the SFI into their data processor (computer). This can be done by scanning the negotiable instrument and/or by keying selected data into a data processor (computer). The data may include (1) a route code and/or account number, (2) a sequence number, (3) the dollar amount, (4) issue date, (5) purchaser, (6) system date and time, (7) money order expiration date, (8) maker name or ID, (9) login and security credentials, and (10) remitter and payee names. If the redeeming agent 16 is using authentication software that resides on the remote (TPAS) server, then the system proceeds to step 202. If on the other hand the redeeming agent 16 is using authentication software residing locally (on the redeeming agent's computer), then the system proceeds directly to step 206.

Step 202: The data is sent in real time to the TPAS central server.

Step 204: The TPAS 14 receives the request, and the data and redeeming agent 16 are checked for validity.

Step 206: The system, either the remote computer or, more typically, the redeeming agent's computer, determines if the SFI is a TPAS item. That is, whether the SFI was generated using the TPAS 14 software and thus its information resides in the TPAS database. Even local computers will have this information because the TPAS computer periodically sends this information to each local computer in the system, typically once per day.

Step 208: If the SFI is an item that is not managed either by the redeeming agent's location or the TPAS, the system sends an error message to the issuing agent.

Step 210: If the SFI is a TPAS 14 item managed either by the redeeming agent's location or the TPAS, the system checks to determine if the data is valid.

Step 212: If either the data or redeeming agent is not valid, the system sends an error message.

Step 214: If the data and redeeming agent are valid, the system analyzes the SFI image.

Step 216: The system searches for a two dimensional barcode. If a two dimensional barcode is not found, the system proceeds to Step 217. If a two dimensional bar code is found, the system proceeds to Step 220.

Step 217: The system checks of an Internet connection. If an Internet connection is not found, the system sends an error message (Step 218). If an Internet connection is found, the system proceeds directly to Step 236.

Step 220: Data is retrieved from the bar code. The data typically includes the secure financial instrument amount, account routing number and sequence number, and may include other information such as remitter and payee information. The data will also include the digital signature.

Step 222: The barcode data is compared to the issuing agent's data entered at point of sale (POS).

Step 224: The system determines whether the barcode data matches the data entered at the POS. The system also verifies the digital signature. To do this the redeeming agent's computer will take the public key out of the file, decrypt the digital signature portion, and compare the digital signature to the information in the barcode and other information which may be entered at the POS to determine whether they match. Should the remote software component not be utilized, all data is sent to TPAS 14, and the system proceeds to step 238.

Step 226: If the data does not match, the system sends a “Do not cash” error message.

Step 228: If the data matches, the system determines whether there is an Internet connection. If an Internet connection is not found, the system sends a message (Step 230) to the redeeming agent 16 that the money order may be cashed, but only with caution. If an Internet connection is found, the system proceeds to Step 236.

Step 230: After sending a caution notice to the redeeming agent 16, the system proceeds to Step 232.

Step 232: The system waits for confirmation from the redeeming agent 16 that the money order has been cashed.

Step 234: The system queues the money order information to send to the TPAS later, when an Internet connection becomes available.

Step 236: If there is an Internet connection, the system sends the Request to cash the money order to the TPAS 14.

Step 238: The TPAS 14 receives the request to authenticate the money order.

Step 240: The TPAS checks the validity of the secure financial instrument data.

Step 242: If the data and redeeming agent 16 information are not valid, the TPAS computer sends the redeeming agent 16 an error message.

Step 244: If the data and redeeming agent 16 information are valid, the TPAS 14 will compare the data sent with its corresponding database entry.

Step 246: If the information on the money order matches the information in the TPAS database, the system proceeds directly to Step 250. If the information on the money order does not match the information in the TPAS database, the system proceeds to Step 248.

Step 248: The TPAS server sends a “do not cash” message to the redeeming agent 16

Step 250: If the data from Step 246 matches, the system determines whether the instrument has already been negotiated (which might occur if the redeeming agent is being presented with a copy of a previously negotiated SFI). If the instrument has been negotiated, the system proceeds to Step 252. If the instrument has not been negotiated, the system proceeds directly to Step 254.

Step 252: The system sends a “Do not cash” message to the user.

Step 254: The system sends the redeeming agent 16 an ‘Ok to cash” message, including information about the issuing agent 12 (maker).

Step 256: The system waits for confirmation from the redeeming agent 16 that the money order or other secure financial instrument has been cashed.

Step 258: Once the redeeming agent 16 receives confirmation from the TPAS 14 and/or the local software component that the secure financial instrument is or is not OK to cash, the redeeming agent 16 may cash or not cash the secure financial instrument. Once the money order is cashed (redeemed), it is marked off as “redeemed” in the central server in real time. All subsequent requests to the server will result in a denial, since the money order has already been redeemed.

### Process for Queue Transmission

An advantage of the present authentication system is that it can operate either in real time (if an Internet connection is available) or offline by entering the request in a queue.

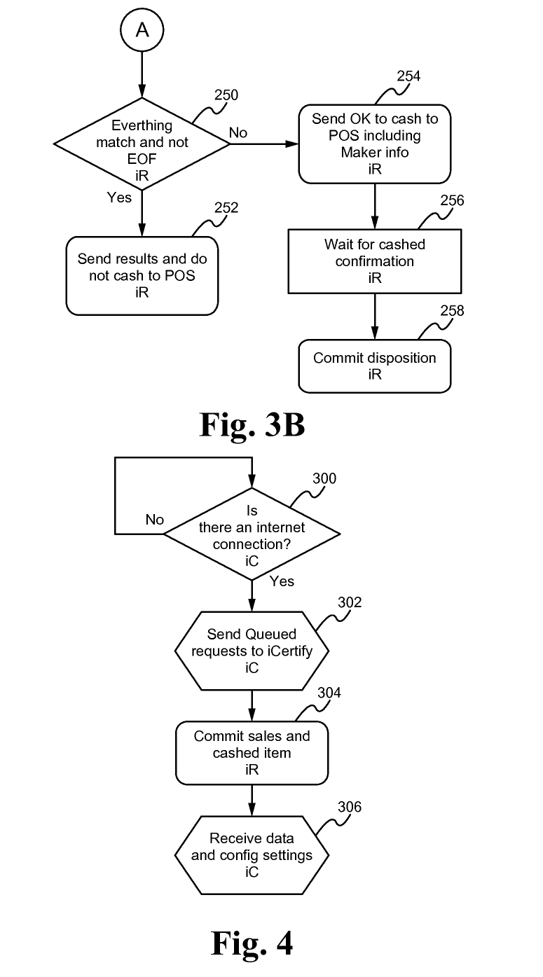

FIG. 4 is a schematic diagram showing a subroutine for queuing a SFI authentication request according to the present invention. The subroutine begins with a Step 300 in which the system checks to determine whether an Internet connection is available. If an Internet connection is available, the system proceeds to a Step 302 in which the request is sent to the TPAS server. In a next Step 304 the TPAS 14 remotely authenticates the data, commits sales and cashed instruments, then sends data and other information to the requester, either an issuing agent 12 or a redeeming agent 16. Reception of data and other information/configuration settings are received in step 306.

### Advantages of the Process and Technology

By utilizing the present invention, the only way to create (sell) a secure financial instrument is to have an issuing agent's private key. Even with the software component residing locally, an authentic SFI cannot be created without an authentic private encryption key. This same methodology prevents alteration of the document, as the two dimensional bar code and digital signature are analyzed and matched to the data on the SFI.

Though it is possible for a single exact facsimile to enter the network by the original having been entered outside the network, this will only happen a maximum of one time within the network. Due to having such a system in place, it is believed that the majority of this type of fraud will be eliminated due to the minimizing of the gain on the part of those doing fraud. Under current authentication systems, hundreds of the same item could hit the banking system in a single day, thus defrauding hundreds of merchants. With the present system, at worst only one participating merchant would lose.

Another feature of the present system is that even if an issuing agent 12 or redeeming agent 16 has a loss of internet access, their systems will still be able to authenticate the item. They will be notified that it cannot be currently verified if an item has been cashed, but it will verify as authentic.

Lastly, the ability to email negotiable instruments now becomes possible. Should there be participating merchants or financial service businesses in an area, an item can be printed out at home or at a business on regular computer paper, and then presented for payment at a participating agent.

It is understood that the embodiments of the invention described above are only particular examples which serve to illustrate the principles of the invention. Modifications and alternative embodiments of the invention are contemplated which do not depart from the scope of the invention as defined by the foregoing teachings and appended claims. It is intended that the claims cover all such modifications and alternative embodiments that fall within their scope.

1. A method for enabling an issuing agent to create a secure financial instrument, comprising the steps of:
(a) pre-registering the issuing agent and a redeeming agent, assigning the issuing agent a private encryption key unique to each agent, and creating issuing agent information accessible via a third party authentication service;
(b) providing document creation software usable by the issuing agent and providing document authentication software usable by the redeeming agent;
(c) providing a central server, operated by the third party authentication service and accessible by every registered issuing agent and redeeming agent, on which resides a database accessible by the issuing agent and the redeeming agent;
(d) enabling the issuing agent to input into the database SFI data relating to the secure financial instrument, the SFI data including a routing number, an ABA account number, a dollar amount, an issue date and remitter, payee and purchaser information;
(e) enabling a third party to check the validity of the SFI data and the issuing agent information offline without requiring a network connection to confirm that the secure financial instrument is authentic with respect to information the secure financial instrument is comprised of;
(f) enabling the third party authentication service to determine whether a committed entry already exists in the database;
(g) enabling the issuing agent to request a two dimensional bar code to accompany the secure financial instrument or generating the two dimensional bar code locally;
(h) enabling the issuing agent to issue the secure financial instrument, either in electronic form or in paper form by printing the secure financial instrument on site using a printer operated by the issuing agent, the secure financial instrument including the two dimensional bar code and a cryptographic digital signature signed with the issuing agent's private encryption key and wherein the cryptographic digital signature requires a corresponding public key to be decrypted and authenticated; and
(i) uploading the SFI data to the central server so that the SFI data is available to every registered redeeming agent upon their request.

2. The method of claim 1 wherein the two dimensional barcode is generated locally, by the computer operated by the issuing agent.

3. The method of claim 1 wherein the two dimensional barcode is generated remotely, by the central server.

4. The method of claim 1 wherein the SFI data is queued up to be transmitted to the third party authentication service if network connectivity is not available.

5. The method of claim 1 wherein the SFI data is transmitted to the third part authentication service without any intentional delay.

6. The method of claim 1 wherein the secure financial instrument is selected from the group consisting of a money order, a check, a voucher, a coupon and a bank draft.

7. A method of enabling a redeeming agent to authenticate a negotiable instrument in real time, comprising the steps of:
receiving from a customer a printed negotiable instrument, the negotiable instrument including a two dimensional bar code, a signature section and a digital signature residing in a signature section, the two dimensional bar code containing negotiable instrument information about the negotiable instrument, wherein the negotiable instrument information has been formerly entered into a database residing on a central server operated by a third party authentication service as a database entry;
enabling the redeeming agent to input locally on the redeeming agent's computer selected data regarding the negotiable instrument;
comparing locally the negotiable instrument information in the bar code to the selected data and verifying the digital signature; and
transmitting the selected data to the third party authentication service so that the third party authentication service can compare the bar code information on the negotiable instrument to the selected data as well as to the database entry in order to verify that the negotiable instrument has not been cashed and then send the redeeming agent an authorization code.

8. The method of claim 7 wherein the redeeming agent inputting step is accomplished by scanning the negotiable instrument.

9. The method of claim 7 wherein the redeeming agent inputting step is accomplished by keying selected data into a computer.

10. A system for creating, authenticating and redeeming a secure financial instrument, the system comprising:
a central server operated by a third party authentication service provider;
a computer operated by an issuing agent and a computer operated by a redeeming agent, each computer being connected through the Internet to the central server;
a printer operated by the issuing agent for printing the secure financial instrument;
a check imaging device operated by the redeeming agent;
secure financial instrument creation software designed for use by the issuing agent, the secure financial instrument creation software residing on the issuing agent's computer or on the central server;
a database comprising a list of all participating issuing agents, the database residing on the central server, the database further comprising account information and a public encryption key for each issuing agent and each redeeming agent;
software for generating a two dimensional bar code and a digital signature for each secure financial instrument created and storing that information on the database; and document authentication software designed for use by the redeeming agent in authenticating a present secure financial instrument, the document authentication software residing on the central server or on the redeeming agent's computer, the documentation software including means for comparing a two dimensional bar code and digital signature associated with the presented secure financial instrument to local data as well as data residing in the database.
